(19) United States
(12) Patent Application Publication
(10) Pub. No.: US 2002/0056675 A1
(43) Pub. Date: May 16, 2002

(54) Gas vent filter construction incorporating a hollow fiber membrane assembly

(76) Inventor: Ramesh Hegde, Chelmsford, MA (US)

Correspondence Address: MILLIPORE COPORATION, 80 ASHBY RD, BEDFORD, MA, 01730, US

(21) Appl. No.: 09/945,169

(22) Filed: Aug. 31, 2001

Related U.S. Application Data
(60) Provisional application No. 60/229,417, filed on Aug. 31, 2000.

(51) Int. Cl. B01D 29/00

(52) U.S. Cl. 210/188

(57) ABSTRACT

A gas vent filter construction is provided that incorporates a hollow fiber membrane assembly as a means for selectively preventing liquid species from escaping from, for example, a substantially closed liquid filtration system, as gas building up therein is vented out of said system through said gas vent filter construction. The gas vent filter construction preferably also comprises a gas-permeable membrane positioned downstream from the hollow fiber membrane assembly. Both single and multiple hollow fiber membranes (preferably, hydrophobic) are considered.

### REFERENCE TO RELATED APPLICATION

This application claims the benefit of Provisional U.S. patent application Ser. No. 60/229,417, filed Aug. 31, 2000.

### FIELD

This invention relates, in general, to a gas vent filter construction, and in particular, to a gas vent filter construction capable of venting gas from a substantially closed liquid process stream, while impeding the release of a liquid species (e.g., aqueous vapor) therefrom.

### BACKGROUND

Separations technology—endowed with a long, distinguished, and well-established history—currently enjoys the growing attention of a broad commercial and scientific community interested in its applicability to critical industrial research and development. Among the important “tools” of separations technology are pressure- and vacuum-driven liquid filtration, which provide inter alia a means by which scientists can effectively purify, concentrate, and/or analyze a given solution.

While subject to broad variation, the principal functional components of a conventional liquid filtration system are its filter element(s) and its encasing housing. The housing typically has an inlet and an outlet. The filter element(s) are typically positioned within the housing to assure that liquid passing through the inlet must pass through the filter element(s) prior to being passed through the outlet.

A common issue associated with conventional liquid filtration systems is the accumulation of gas within the housing, which can—if not addressed—reduce or block liquid flow through the housing. Because such condition can unacceptably reduce the efficacy of the filtration system, the housings of many such systems are often provided with a membrane-based gas vent to release gas from the affected area, without release of the liquid being filtered. A popular structural configuration for such gas vent comprises a hydrophobic membrane filter positioned within a passage, the passage being defined by a surrounding housing, the surrounding housing capable of effecting non-leaky fluid communication between said passage and an interior portion of the liquid filtration system where gas tends to accumulate. An example is illustrated in FIG. 1.

As shown therein, gas vent 5 comprises a housing formed of two sections 12 and 14 sealed together and a hydrophobic membrane 16 positioned therebetween. The housing includes an inlet orifice 18 in fluid communication with an inlet passage 20. The housing also includes an outlet orifice 22 in fluid communication with passage 24. In operation, gas passes through inlet orifice 18, passage 20, membrane 16, passage 24 and outlet orifice 22, thereby removing gas from a housing (not shown) in fluid communication with inlet orifice 18, while maintaining containment of the liquid process stream.

While the gas vents of the type illustrated in FIG. 1 continue to be used widely and effectively, need is felt for furthering their applicability to meet, for example, even more rigidly-controlled filtration protocols. In this regard, a number of interrelated issues are noted.

First, the membrane filter elements 16 used in the conventional gas vent filters 5 are generally mechanically fragile, and accordingly, subject under certain conditions to ripping, tearing, or like destruction.

Second, in the aforementioned filtration protocols, rigid control over containment of the liquid process stream is often necessitated due to the scarcity and/or expensiveness of the liquid, or its corrosiveness and/or toxicity. Unintended release of such liquid, due to mechanical failure of a membrane filter element 16, would likely be unacceptable.

Third, in consideration of the fragility of typical membrane filter elements 16, the inlet orifice 18 of the gas vent 5 is often purposefully made relatively small so that the total atmospheric force exerted on the membrane filter 16 will be below the point at which the filter 16 will rupture. Unfortunately, the smaller the size of orifice, the more restricted the gas flow through the filter.

Fourth, it has been observed that, in a conventional gas vent 5, volumes of liquid greater than desirable can sometimes enter into the vent and—despite its hydrophobicity—wet the membrane filter element 16. A wet membrane filter element 16 may not allow freely the transit of gas therethrough, and accordingly, may undesirably restrict gas flow out of the vent 5. Should this occur undetected, excessive gas can accumulate and exert excessive pressure on the membrane filter element 16, potentially leading to catastrophic system failure. Even if detected, valuable product and production time can be compromised upon taking appropriate remedial actions, for example, as one shuts down the system to replace or dry out the vent membrane.

### SUMMARY

In consideration of the aforementioned need, the present invention provides a gas vent filter construction which—when employed, for example, as a venting mechanism in a substantially “closed” vacuum-or pressure-driven filtration unit—is capable of venting gas accumulating in said unit, while impeding the release of any liquid species (e.g., aqueous vapor) flowing or otherwise in transit therethrough. This is accomplished by the gas vent filter construction by the incorporation therein of a hollow (preferably hydrophobic) fiber membrane assembly.

In its principal embodiment, the gas vent filter construction comprises a housing and the hollow fiber membrane assembly. The housing defines a passage having an inlet and an outlet, and is capable of containing a gas flowing therethrough. The hollow fiber membrane assembly is inserted (at least partially) into said passage through said inlet and is configured such that it is capable of admitting gas into the passage.

As will be described below, the gas vent filter construction is subject to several broad embodiments. For example, the hollow fiber membrane assembly can be hydrophobic (or not), or can comprise either a single hollow fiber membrane or a bunch of hollow fiber membranes. The gas vent filter construction can also further comprise a gas-permeable membrane, preferably hydrophobic, positioned downstream from the hollow fiber membrane assembly. Several other variations are disclosed.

In light of the above, it is a principal objective of the present invention to provide a novel gas vent filter construction for venting gas from a substantially closed system, such as certain vacuum- or pressure-driven filtration systems.

It is another objective of the present invention to provide a gas vent filter construction incorporating a hollow fiber membrane assembly.

It is another objection of the present invention to provide a gas vent filter construction capable of serving as an effective means for venting a gas from a vacuum- or pressure-driven liquid filtration systems, while impeding the unwanted release of liquid species flowing or otherwise in transit therethrough.

With these and other objects in view, which will more readily become apparent as the nature of the invention is better understood, the invention subsists in its novel combination and assembly of parts hereinafter more fully described and claimed.

### BRIEF DESCRIPTION OF THE DRAWINGS

Each of FIGS. 1 to 5 provide schematic representational illustrations. The relative location, shapes, and sizes of objects have been exaggerated (particularly, the gaseous species 34 in FIGS. 4 and 5) to facilitate discussion and presentation herein.

FIG. 1—discussed infra—is a cross-sectional view of a vent filter construction 5, according to a prior art embodiment thereof.

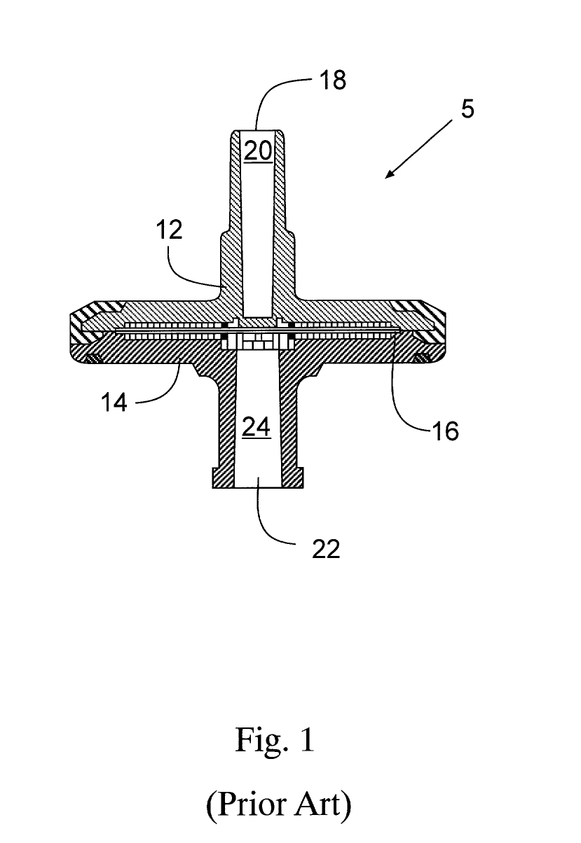

FIG. 2 is a cross-sectional view of a gas vent filter construction 10, according to one embodiment of the present invention.

FIG. 3 is an exploded partial view of the gas vent filter construction 10 of FIG. 2.

FIG. 4 is a schematic view of a filtration construction 410 utilizing the gas vent filter construction 10 of FIG. 2, in accordance with a novel application of the present invention.

FIG. 5 is a schematic view of another filtration construction 510 utilizing the gas vent filter construction of FIG. 2, in accordance with another novel application of the present invention.

### DETAILED DESCRIPTION

The present invention provides a gas vent filter construction that can be coupled to a larger “host” liquid filtration system to provide an improved means for carefully releasing gas that can accumulate undesirably therein, while providing a robust and durable aqueous barrier.

The gas vent filter construction, in general, comprises a housing and a hollow fiber membrane assembly. The housing—subject to broad and several variations—defines in all instances a passage that has an inlet and an outlet and is capable of containing (i.e., without inordinate leakage) a flow of gas. The hollow fiber membrane assembly—subject also to broad and several variations—is in all instances inserted into the passage and is specifically configured to admit gas, but not liquid, into said passage.

Typically, the hollow fiber membrane assembly comprises one or a plurality of hollow fiber membranes and a plug positioned proximate to and sealing the passage inlet. The hollow fiber membrane(s) breach, pierce, penetrate, or otherwise extend through the plug such that gas can be admitted into the passage beyond said plug through the internal channel (i.e., the lumen) that runs completely or substantially the entire length of each hollow fiber membrane.

In embodiments of the present invention wherein the hollow fiber membrane(s) are composed of hydrophobic material, aqueous constituents from a liquid process stream (e.g., from or as a result of rising sample liquid volume or fugitive liquid vapor) will not readily (if at all) permeate the hollow fiber membrane's outer walls, nor proceed easily through the fiber membrane's lumen.

As will be appreciated by those skilled in the art, the functionality (and effectiveness) of the hollow fiber membrane will be influenced in part by, for example, the length of the fiber membrane, its internal diameter, the chemical and rheological properties of the liquid process stream, and the anticipated operating pressures generated in filtration. Consideration of these and other factors will enable those skilled in the art to devise, in respect of their desired application, useful hollow fiber membrane structures and compositions, and incorporate such into embodiments within the ambit of the present invention.

In most embodiments, the hollow fiber membrane assembly will not be the only component of the gas vent filter construction incorporated therein to “scrub” vented gas of liquid species. For more tightly-controlled filtered gas venting, it is more desirable not to employ the hollow fiber membrane assembly in isolation, but as a “pre-filter” to a second filtration unit positioned further downstream in the housing's passage. In this regard, because liquid is substantially excluded from the vented gas upstream by the hollow fiber membrane assembly, a more sensitive filter (i.e., a membrane) can be employed downstream, the selection and/or configuration thereof being correspondingly liberated from the aforementioned prior art issues of fragility, tearing, ripping, premature clogging, and the like. Good results can be accomplished, for example, by pairing a hydrophobic gas-permeable membrane with a hydrophobic hollow fiber membrane assembly.

Also, the downstream membrane should preferably have a composition such that if “wet” by liquid breaching the upstream hollow fiber membrane assembly, the gas flow rate therethrough will decline dramatically. By such functionality, expiration of the hollow fiber membrane assembly can be determined easily by monitoring venting efficacy, allowing ample opportunity for unit replacement before liquid is discharged from a filtration system. Such safeguard is particularly desirable in filtration systems utilized in semiconductor fabrication, wherein caustic, noxious, and/or toxic liquid constituents are often present in the liquid process stream. Those skilled in the art will know of gas permeable membranes that “shut down” upon “wetting”.

While the gas vent filter construction can be employed in several and varying applications wherein filtered gas venting is desired, in its preferred application, it is coupled to another filtration construction, i.e., a “host” liquid filtration system. A typical host liquid filtration system—which in concept resembles to some extent a larger version of the gas vent filter construction—comprises a filtration housing and a selectively-permeable filtration element. The filtration housing defines a filtration passage that has a filtration inlet and a filtration outlet and is capable of containing a liquid process stream flowing therethrough. The selectively-permeable filtration element is positioned in the filtration passage between the filtration inlet and the filtration outlet such that the liquid process stream must flow through the filtration element as it flows through the filtration passage.

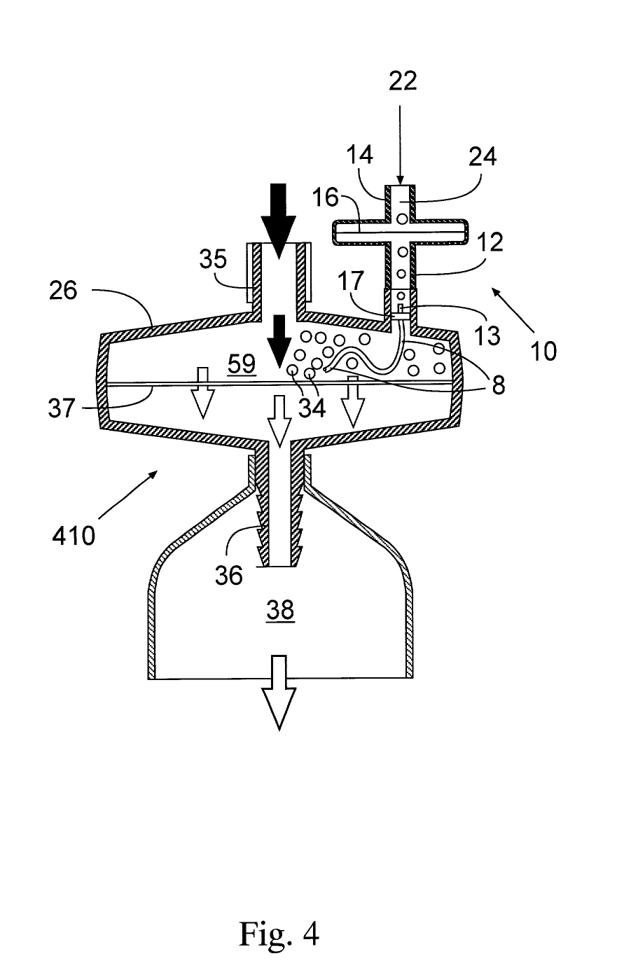

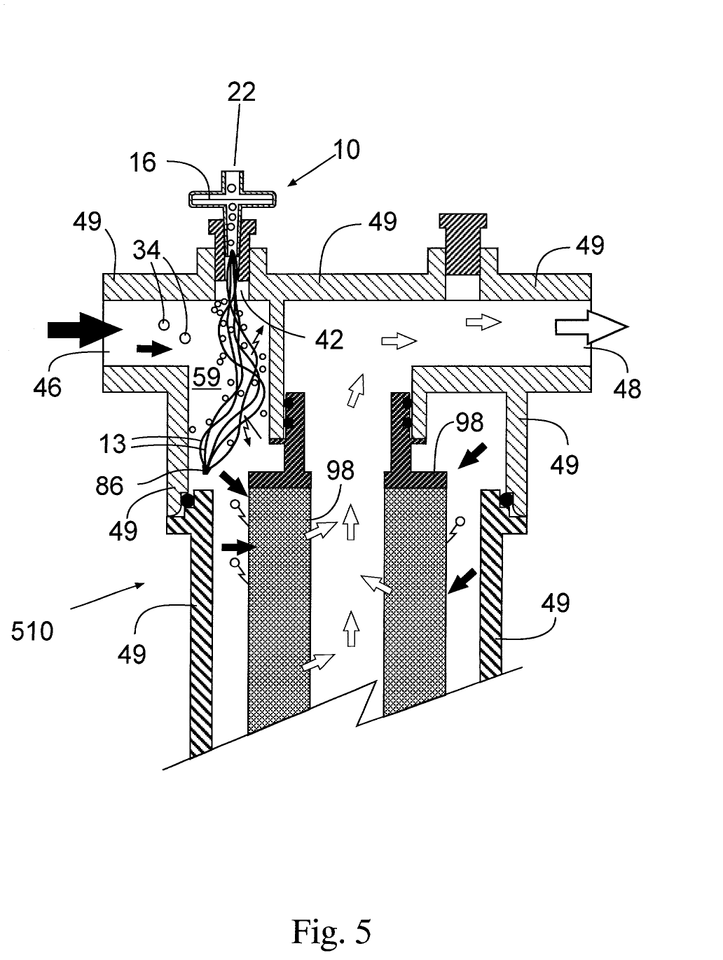

During the filtration of a liquid process stream in the liquid filter assembly, gas can accumulate in the area between the assembly's filtration inlet and its selectively-permeable filtration element. (See, area 59 in FIGS. 4 and 5.) The gas vent filter construction is thus targeted into this area to vent or otherwise release accumulated gas, which—as discussed above—can be potentially problematic. In particular, the gas vent filter construction is mated, plugged or inserted into, or otherwise coupled with the assembly's filtration passage through its housing at a position between the filtration inlet and the selectively-permeable filtration element such that at least one of the gas vent filter construction's hollow fiber membranes extends between the gas vent filter construction's passage and the liquid filter assembly's passage. This establishes a route between the two internal passageways through which gas can flow, and be subsequently vented. The plug used in the gas vent filter construction—as mentioned—can prevent, restrict, constrain, or otherwise block entry of gas from the assembly's passage into the vent's passage other than by transit through the hollow fiber membrane. Specific representative embodiments of such application are illustrated schematically in FIGS. 4 and 5, discussed in greater detail below.

In respect of its hollow fiber membrane assembly, the present invention utilizes preferably hydrophobic hollow fiber ultrafiltration or microfiltration membranes, such as hollow fiber membranes formed of a fluoropolymer; such as a perfluoroalkox-modified polymer, polyvinylidene difluoride, or the like; or a hollow fiber filter formed of any polymeric composition which is surface modified with an oleophobic or hydrophobic composition, such as a fluoropolymer, including crosslinked coatings containing perfluoroacrylates or methacrylate polymers/perfluoro acrylamide, methalamide and the like (polysilicone) crosslinked dimethyl siloxane or fluoro containing siloxane or the like.

The material for the hollow fiber membranes may be synthetic or natural and may be inorganic, organic or organic mixed with inorganic. Typical inorganic materials for the hollow fiber membranes may be glasses, ceramics, cermets, metals, and the like. The organic materials are generally polymeric in nature. Typical polymers suitable for the hollow fiber membranes can be substituted or unsubstituted polymers and may be selected from polysulfones; poly(styrenes), including styrene-containing copolymers such as acrylonitrile-styrene copolymers, styrene-butadiene copolymers and styrene-vinylbenzylhalide copolymers; polycarbonates; cellulosic polymers, such as cellulose acetate-butyrate; cellulose propionate, ethyl cellulose, methyl cellulose, nitrocellulose, etc.; polyamides and polyimides, including aryl polyamides and aryl polyimides; polyethers; poly(arylene oxides) such as poly(phenylene oxide) and poly(xylylene oxide); poly(esteramide-diisocyanate); polyurethanes; polyesters (including polyarylates) such as poly(ethylene terephthalate), poly(alkyl methacrylates), poly(alkyl acrylates), poly(phenylene terephthalate), etc.; polysulfides; poly(siloxanes); polymers from monomers having the alpha-olefinic unsaturation other than mentioned above such as poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl phosphates), and poly(vinyl sulfates); polyallyls; poly(benzobenzimidazole); polyhydrazides; polyoxadiazoles; polytriazoles; poly(benzimidazole); polycarbodiimides; polyphosphazines; etc., and interpolymers, including block interpolymers containing repeating units from the above and grafts and blends containing any of the foregoing. Typical substituents providing substituted polymers include halogens such as fluorine, chlorine and bromine; hydroxy groups, lower alkyl groups; lower alkoxy groups; monocyclic aryl; lower acyl groups and the like. The polymer may contain modifiers, plasticizers, fillers, etc.

Hollow fiber membranes, useful in the present invention, can be obtained commercially. For example, a hydrophobic polyethylene-based hollow fiber membrane is sold under the tradename “Sterapore” by Mitsubishi Rayon (Minato-Ku, Tokyo 108-8506, Japan). Alternatively, a hollow fiber membrane is distributed by Pall Corporation (East Hills, N.Y. 11548) under the tradename “Microza”. Others are certainly available.

Methods for the manufacture of hollow fiber membranes (including both hydrophobic and hydrophilic varieties) are well-documented in the scientific and patent literature. See e.g., U.S. Pat. No. 4,678,581, issued to T. Nogi et al. on Jul. 7, 1987; U.S. Pat. No. 5,277,851, issued to D. Ford et al. on Jan. 11, 1994; U.S. Pat. No. 5,294,338, issued to J. Kamo et al. on Mar. 15, 1994; U.S. Pat. No. 5,480,553, issued to H. Yamamori on Jan. 2, 1996; U.S. Pat. No. 4,020,230, issued to R. D. Mahoney et al. on Apr. 26, 1977; and U.S. Pat. No. 4,055,696, issued to K. Kamada et al. on Oct. 25, 1977.

More particularly, for example, U.S. Pat. No. 4,020,230 (Mahoney et al.) discloses a process wherein microporous, normally hydrophobic hollow fibers are prepared by spinning a homogeneous solution of polyethylene and an alkoxyalkyl ester in hollow fiber form, gelling the forming fibers, drawing the fibers in a solidified gel state and then contacting the drawn fibers with a liquid ester-removal medium and removing at least a major proportion of the ester. The pores in the resultant fibers are contiguous between the inner and outer fiber surfaces. The fibers have O₂ permeabilities of from about 2×10⁻⁵ to about 1×10⁻² c.c. per cm² per second per cm Hg. transmembrane pressure, the c.c.'s of oxygen being corrected to standard temperature and pressure (STP).

Alternatively, U.S. Pat. No. 4,055,696 (Kamada et al.) discloses a process for the manufacture of porous polypropylene hollow filaments having a surrounding wall portion with a thickness less than 60 microns and pore diameters in the range of 200-1200 Angstroms. The suggested method for making such filaments involves melt spinning polypropylene by a nozzle for production of hollow filaments at a spinning temperature of 210° C.-270° C. and a draft of 180-600, then subjecting the resultant filaments to a first heat treatment at a temperature of not higher than 160° C., thereafter stretching them by 30-200% at a temperature lower than 110° C. and then subjecting them to a second heat treatment at a temperature not lower than the temperature of the first heat treatment and not higher than 175° C.

In desirable embodiments of the present invention, the hollow fiber membrane is both hydrophobic and has a porosity that would classify it in the art as either a so-called “ultrafiltration” or so-called “microfiltration” membrane. An ultrafiltration membrane has an average pore size between about 0.005 microns and about 0.01 microns; a microfiltration membrane has an average pore size between about 0.01 microns and about 10 microns. Preferably, the hydrophobicity (or oleophobicity) of the hollow fiber membrane, as measured by its surface energy, should be less than about 20 dynes/cm², and even more preferably, less than about 12 dynes/cm².

The hollow fiber membrane may be of any convenient configuration, e.g., circular, hexagonal, trilobal, or the like in cross-section and may have ridges, grooves, or the like extending inwardly or outwardly from the walls of the hollow fiber membranes. The hollow fiber membrane may be isotropic, i.e., having substantially the same structure throughout the thickness of the wall, or anisotropic, i.e., having one or more regions within the thickness of the wall having a more dense structure.

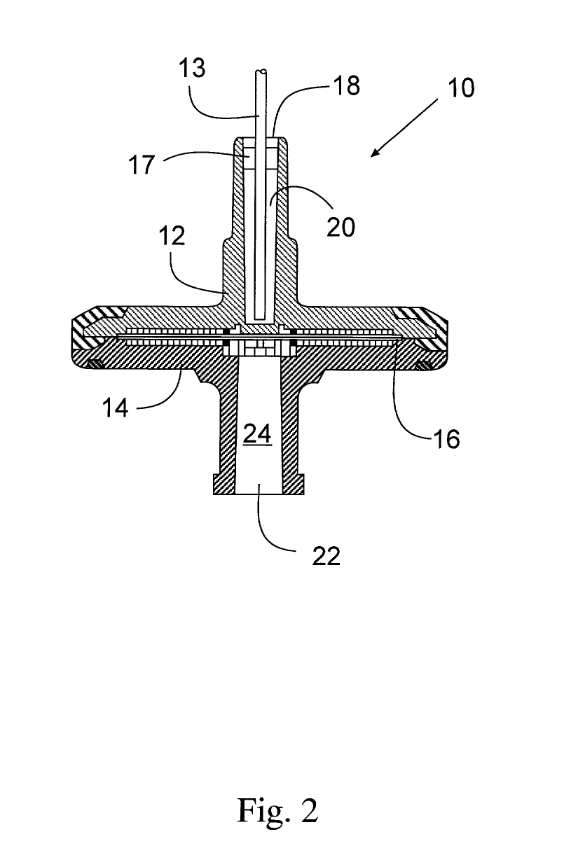

It should be apparent that the present invention described herein invites and accommodates several and broad variation in respect, for example, of its structure, manufacture, and application. Provided with the teachings herein, the practice of all such particular embodiments are felt to fall within the “skill in the art”. Regardless, representative (non-limiting) examples of such embodiments are set forth in FIGS. 2, 3, 4, and 5.

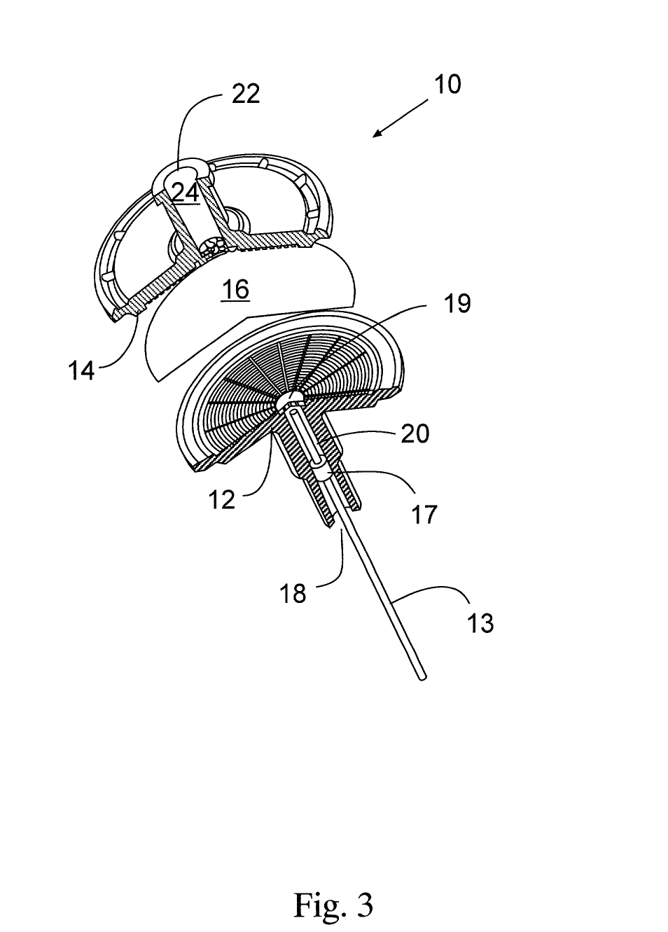

Attention is directed initially to the particular embodiment illustrated in FIGS. 2 and 3. The gas vent filter construction 10 illustrated therein is presently the preferred embodiment of the invention.

Gas vent construction 10 of FIGS. 2 and 3 comprises a housing formed of two sections 12 and 14 sealed together and a hydrophobic membrane 16 positioned between the sections 12 and 14. The housing includes an inlet orifice 18 in fluid communication with inlet passage 20. The housing also includes an outlet orifice 22 in fluid communication with passage 24. A hydrophobic hollow fiber membrane 13 is secured to an interior wall 15 of inlet orifice 18 by potting composition 17 (i.e., a plug) in a manner which permits gas flow into passage 20 exclusively through the hollow fiber 13. In operation, gas passes through inlet orifice 18, passage 20, membrane 16, passage 24 and outlet orifice 22, thereby removing gas from a housing (not shown) in fluid communication with inlet orifice 18.

As more completely viewable in FIG. 3, housing section 12 includes a porous surface formed of ribs 19 which functions to permit gas flow therethrough while providing mechanical support for the membrane 16 and thereby significantly reducing mechanical damage to the membrane 16 while gas is passing therethrough. A similar construction is provided in housing section 14.

The potting material that forms plug 17 may comprise any suitable material. See generally, U.S. Pat. No. 3,228,877, issued to H. Mahon on Jan. 11, 1966; U.S. Pat. No. 3,339,341, issued to J. Maxwell et al. on Sep. 5, 1967; U.S. Pat. No. 3,442,002, issued to J. Geary et al. on May 6, 1976; U.S. Pat. No. 3,962,094, issued to J. Davis et al. on Jun. 8, 1976; U.S. Pat. No. 4,369,605, issued to E. Opersteny et al. on Jan. 25, 1983; and U.S. Pat. No. 4,865,735, issued to Y. Chu et al. on Sep. 12, 1989.

Preferably, the potting material is initially in liquid form, and in the process of assembling the gas vent filter construction 10, is thereafter solidified, e.g., by cooling, curing, or the like. The solidified potting material should exhibit sufficient structural strength for plugging passage 20 and be relatively inert to moieties to which it will be exposed during gas venting operations. Often, a useful guide for selecting suitable materials for the potting material is the impact strength of the solid potting material. For instance, suitable solid potting materials frequently exhibit an Izod impact strength (ASTM D-256) of at least about 0.05, e.g., say, about 1 to 100 or more, centimeter-kilogram per centimeter of notch.

The potting material may be organic, inorganic or organic containing inorganic material, and the potting material may be natural or synthetic. Typical inorganic materials include glasses, ceramics, cermets, metals, and the like. Conveniently, the potting material comprises a solidifiable resin. Typical resins include phenolaldehyde resins, melamine-aldehyde resins, thermosetting artificial rubbers, acrylic resins, urethane resins, silicone resins, polysulfides, acetals, cellulosics, fluorocarbons, vinyls, styrenes, polyethylene, polypropylene, and other olefinically-unsaturated monomers, and the like. Particularly attractive potting materials are the epoxy resins, e.g., from polyglycyl resins preferably containing one or more diglycidyl compounds (including glycidyl-terminated prepolymers). Often the polyglycidyl resins are polyglycidyl ethers derived from resorcinol, catechol, hydroquinone, phloroglucinol, 4,4′-dihydroxybenzophenone, 1,1-bis(4-hydroxyphenyl) ethane, 2,2-bis(4-hydroxyphenyl) propane (Bisphenol A), bis(2-hydroxynaphthyl) methane, 2,2-bis(4-hydroxyphenyl) butane, 4,4′-dihydroxyphenyl phenyl sulfone, ethylene glycol, propylene glycol, butanediol, pentanediol, isopentanediol, in oleic dimer acid, poly(oxypropylene) glycol, 2,4,4′-trihydroxybisphenyl, 2,2′-4,4′-tetrahydroxybisphenyl, Bisresorcinol F, 2,2′-4,4′-tetrahydroxy benzophenone, 1,1-bis(hydroxyphenyl) cyclohexane, bisphenol-hexafluoroacetone, aniline, paraaminophenol, isocyanurate, cyanuric chloride, hydantoin, tetraphenylene ethane, phenol-formaldehyde novolac, o-creson-formaldehyde novolac, cycloaliphatic epoxy resins, and the like. These resins may be substituted, e.g., with hydroxyl or halogen moieties, e.g., fluorine, chlorine and bromine (such as tetrabrominated bisphenol A).

Commonly, the epoxy is cured with a curing agent. Examples of curing agents include polyamines, polymethylenediamines, polyalkyletherdiamines, dialkylenetriamines (e.g., diethylenetriamine), trialkylenetetraamines (e.g., triethylenetetraamine), N-aminoethylethanol amine, 1,3-bis(dimethylamino)-2-propanol, menthanediamine, amino ethylpiperazine, 1,3-diaminocyclohexane, bis(p-aminocyclohexyl) methane, m-phenylenediamine, m-xylylenediamine, 4,4′-diaminodiphenylmethane, diaminodiphenylsulfone, piperazine, N-methylpiperazine, 2,4,6-tris(dimethylaminomethyl) phenol (DMP-30), tri-2-ethylhexoate salt of DMP-30, modified aliphatic polyamines such as halohydrin ethers of glycol polyamine adducts, dimethamine adducts of alloocimene diepoxide, amino alkoxysilane adducts of propylene oxide, hydroxypolyamines, etc.; imidazole curing agents such as imidazole, N-butylimidazole, 1-acetylimidazole, 1-trifluoroacetylimidazole, 1-perfluorobenzoylimidazole, 1,2-dimethylimidazole, 2-methylimidazole, 2-ethylimidazole, 2-nitroimidazole, 2-ethyl-4-methyl-imidazole, 2-methyl-5-nitroimidazole, 4-phenylimidazole, 4,5-diphenylimidazole, 4-nitroimidazole, and benzimidazole; acidic curing agents such as boron trifluoride, aluminum chloride, boron trifluoride monoethylamine, maleic anhydride, phthalic anhydride, chlorendic anhydride, pyromellitic dianhydride, benzophenonetetracarboxylic dianhydride, dodecenyl succinic anhydride, nadic methyl anhydride, tetrahydrophthalic anhydride, hexahydrophthalic anhydride, etc.; amides such as amidopolyamines, fatty polyamines, phosphorous amides (e.g., p-phenylene bis(anilinophenylphosphine oxide)); ureas (including substituted ureas and urea-formaldehydes); N,N-diallylmelamine; triallyl cyanurate; hydrazides; amino acetals such as bis(2-dimethylaminoethoxy) methane, bis(1-dimethylamino-2-propoxy) methane, 1,6-bis(2-dimethylaminoethoxy) hexane, α,α-bis(2-dimethylaminoethoxy)-p-xylene, bis(3-dimethylamino-1-propoxy) methane, 2,6-bis(2-dimethyl aminoethoxy) pyridine, 2,6-bis(1-dimethylamino-2-propoxy) pyridine, 2,6-bis(3-dimethylamino-1-propoxy) pyridine, bis(2-dimethylaminoethoxy) methane, bis(2-N-morpholinoethoxy) methane, 1,1-bis(2-dimethyl aminoethoxy) propane, 2,2-bis(2-dimethylaminoethoxy) propane, α,α′-bis(2-dimethylaminoethoxy) toluene, 1,1-bis(2-dimethyl aminoethoxy) butane, 1,1-bis(2-dimethylaminoethoxy) ethane, and 1,1,2,2-tetrakis(2-dimethylaminoethoxy) ethane; and the like.

The potting material may contain other components such as plasticizers, bond promoting agents, cure accelerators, thickening agents, dyes and pigments.

Planar hydrophobic membranes 16 suitable for use in the gas vent filter construction 10 can, for example, be composed of polytetrafluoroethylene (PTFE), a material which generally yields good hydrophobicity and oleophobicity. Planar hydrophobic membranes—of the PTFE variety and others—are currently commercially available from, for example, Millipore Corporation (Bedford, Mass. 01730) under the tradenames “Fluoropore” and “Mitex” ; Pall Corporation (East Hills, N.Y. 11548) under the tradenames “PharmAssure” “Oxygenator” and “Emflon”; and Sartorious AG (Goettingen, Germany) under the trade designation “Laboratory Microfilter Hydrophobic PTFE Membranes, type 118”. Others are available.

Methods for the manufacture of planar hydrophobic membrane 16 are well-known in the art. See e.g., U.S. Pat. No. 5,217,802, issued to L. Scarmoutzos on Jun. 8, 1993; U.S. Pat. No. 5,037,457; U.S. Pat. No. 4,954,256, issued to P. Degen on Sep. 4, 1990; U.S. Pat. No. 5,037,457, issued to P. Goldsmith et al. on Aug. 6, 1991; and U.S. Pat. No. 5,554,414, issued to W. Moya et al. on Sep. 10, 1996.

The planar hydrophobic membrane 16 can be made intrinsically hydrophobic, or by coating, coating with cross-linking, or grafting techniques to modify the surface characteristics of a polymer substrate. Typical examples of grafting techniques are shown, for example, in U.S. Pats. Nos. 3,253,057; 4,151,225; 4,278,777and 4,311,573.

In respect of an application embodiment of the present invention, attention is now directed to FIG. 4. Therein, there is illustrated a vented liquid filtration system 410 employing a disk-like, planar, semi-permeable filtration element 37.

More particularly, vented liquid filtration system 410 comprises a filtration housing 26 and the filtration element 37. As shown, the filtration housing 26 defines a filtration passage having a filtration inlet 35 and a filtration outlet 36 and—as schematically represented by the use of the larger graphical arrows—is capable of containing a liquid process stream flowing therethrough. The selectively-permeable filtration element 37 is positioned in the filtration passage between the filtration inlet 35 and the filtration outlet 36 such that the liquid process stream must pass through the filtration element 37 as its flows through the filtration passage.

Other liquid filtration system 410 that employ disk-like, planar, semi-permeable filtration elements are disclosed, for example, in U.S. Pat. No. 5,725,763, issued to L. Bonhomme et al. on Mar. 10, 1998; and U.S. Pat. No. 5,603,900, issued to P. Clark et al. on Feb. 18, 1997; and are commercially available, for example, from Millipore Corporation (Bedford, Mass. 01730) under the tradenames “Sterivex”, “Steripak”, “Millipak”, and “Sterivak”.

In the vented liquid filtration system 410 of FIG. 4, a gas vent filter construction 10 is coupled to filtration housing 26. The gas vent filter construction is the same as illustrated in FIGS. 2 and 3, and accordingly, comprises a hollow fiber membrane assembly (i.e., the combination of hollow fiber membrane 13 and plug 17) inserted into the passage defined by housing 12, 14, through inlet 18 (not shown). Gas vent filter construction 10 is also provided with a hydrophobic membrane 16.

The present invention is not limited to any specific means of coupling. Coupling, for example, can be accomplished by either a seamless and integral union, or by the agency of interlocking or otherwise mateable elements provided on the filtration housing 26 and gas vent filter construction 10, respectively. Regardless of the specific means selected, in all instances, the coupling is accomplished such that a section 8 of the hollow fiber membrane 13 extends into or is otherwise in or brought into direct contact to or with the liquid process stream being filtered.

In operation, liquid to be filtered is brought into liquid filtration system 410 through inlet 35, whereupon it contacts and passes through filtration element 37, and is ultimately, released through outlet 36 out of the system 410 into an external reservoir or other vessel 38. During filtration, gas bubbles 34 introduced by or formed in the liquid process stream are unable to pass through filtration element 37, and accordingly, collect in area 59. Due to the pressure differential between area 59 and the external ambient environment, upon contact with the section 8 of hollow fiber membrane 13, gas is assimilated through the fiber membrane walls, and flows into the fiber membrane's lumen, then into and ultimately out of the vent filter construction 10's passage through outlet 22.

The liquid of the process stream is generally impeded from following the path taken by the vented gas due to the liquid-resistant configuration and composition of the hollow fiber membrane 13. Any liquid that perchance passes through the hollow fiber membrane assembly is further prevented from being vented out of the system by membrane 16. As mentioned above, the vent should preferably “shut down” at this point.

A vented liquid filtration system, according to the present invention, need not employ a disk-like, planar, semi-permeable filtration element exclusively. Other varieties of filtration elements can be use. For example, as illustrated in FIG. 5, a vented liquid filtration system can employ a filter cartridge 98.

The vented liquid filtration system 510 of FIG. 5—like system 410 of FIG. 4—comprises a filtration housing 49 and filtration element 98. As shown, the filtration housing 49 defines a non-linear filtration passage having a filtration inlet 46 and a filtration outlet 48 and—as schematically represented by the use of the larger graphical arrows—is capable of containing a liquid process stream flowing therethrough. The selectively-permeable filtration cartridge 37 is positioned in the filtration passage between the filtration inlet 46 and the filtration outlet 48 such that the liquid process stream must pass through the filtration element 37 as its flows through the filtration passage.

Other liquid filtration system 510 that employ semi-permeable filtration cartridges are disclosed, for example, in U.S. Pat. No. 6,231,770, issued to T. Bermann et al. on May 15, 2001; U.S. Pat. No. 6,110,368, issued to S. Hopkins et al. on Aug. 29, 2000; U.S. Pat. No. 5,776,342, issued to H. Hiranaga on Jul. 7, 1998; and U.S. Pat. No. 5,605,625, issued to S. Mills on Feb. 25, 1997.

As was the case with vented liquid filtration system 410 of FIG. 4, a gas vent filter construction 10 is also coupled to the housing 26 of filtration system 510 at a position and manner suitable to allow venting of gas 34from area 59.

The gas vent filter 10 of system 510 functions essentially in the same manner as gas vent filter 10 of system 410, but is distinguished by its use in its hollow fiber membrane assembly of a plurality of hollow fiber membranes 13, rather than a single hollow fiber membrane. This substantially increases the active surface area of the membrane assembly available for gas assimilation, and thus, improves the gas vent filter construction's 10 gas flow rate capacity.

It will be noted that terminal ends of each of the hollow fiber membranes 13 are fused, joined, or otherwise grouped together at a common point 86. When done with uneven lengths of fiber membranes 13—as shown in FIG. 5—this effectively prevents the individual fiber membranes from coalescing lengthwise, a circumstance which would otherwise reduce significantly their exposed surface area. Preferably, grouping is accomplished by thermal fusion, preferably at a temperature sufficient to also collapse the fiber's lumen at said terminal ends (e.g., a temperature exceeding the glass transition temperature of the membrane's polymeric composition).

The use of several hollow fiber membranes is not limited to vented liquid filtration systems 510 that employ semi-permeable filter cartridges 98. Such vent filter 10 can also be employed to advantage in vented liquid filtration systems of the type illustrated in FIG. 4.

Likewise, the collapsing of a hollow fiber member at its terminal element—which seals off a potential avenue for liquid intrusion—is not limited to gas vent filter construction 10 that employ a plurality of hollow fiber membranes. This feature is also employed to similar advantage in single fiber assemblies. A hollow fiber membrane configuration that does not require collapsing of the membrane's terminal end is a hollow fiber membrane loop, wherein the fiber membrane is looped such that both the leading and terminal ends of membrane are posited in the vent filter construction's passage beyond the plug.

Finally, it is noted that, under certain circumstances, the potting of a hollow fiber membrane bundle within the passage of the gas vent filter construction 10 may be difficult. The greater amount of interstitial spaces between fibers involved, and the need to fill and form tight seals therebetween, renders formation of a tight plug comparatively more challenging. Regardless, there are ways in which such can be effectively accomplished.

For example, under one methodology, the hollow fiber membranes of the bundle are fabricated from an ultra-high molecular weight polyethylene (i.e., a molecular weight greater than 500,000 Daltons), collected into a bundle, and contacted with an extrusion of molten thermoplastic polymer at a contact temperature which is higher than the polyethylene membrane polymer. This high temperature application of sealing polymer does not collapse or otherwise deform the lumen of the hollow fiber, while assuring that the polymer can be applied with sufficiently low viscosity to provide adequate penetration around the individual fibers of the bundle to form an integral seal thereabout. Further detail regarding such methodology can be found in U.S. Pat. No. 5,695,702, issued to J. K. Niermeyer on Dec. 9, 1997.

Those skilled in the art, having the benefit of the teachings of the present invention set forth herein, can effect numerous modifications thereto. These modifications are to be considered as being encompassed within the scope of the present invention as set forth in the appended claims.

1. A gas vent filter construction comprising:
a housing defining a passage having an inlet and an outlet, said passage capable of containing a gas flowing therethrough;
and a hollow fiber membrane assembly inserted into said passage through said inlet, said hollow fiber membrane assembly capable of admitting said gas into said passage.

2. The gas vent filter construction of claim 1, wherein said hollow fiber membrane assembly comprises at least one hollow fiber membrane and a plug positioned proximate to and sealing the inlet of said passage, said at least one hollow fiber membrane penetrating said plug, whereby said gas is admittable into said passage beyond said plug through said at least one hollow fiber membrane.

3. The gas vent filter construction of claim 2, wherein said hollow fiber membrane assembly comprises a plurality of hollow fiber membranes.

4. The gas vent filter construction of claim 2, wherein all of the hollow fiber membranes of said hollow fiber membrane assembly are substantially hydrophobic, whereby aqueous liquid species are substantially impeded from admission into said passage.

5. The gas vent filter construction of claim 1, further comprising:
a gas-permeable membrane positioned in said passage between said inlet and said outlet, whereby gas flowing through said passage must pass through said gas-permeable membrane.

6. The gas vent filter construction of claim 4, further comprising:
a gas-permeable hydrophobic membrane positioned in said passage between said inlet and said outlet, whereby gas flowing through said passage must pass through said gas-permeable hydrophobic membrane.

7. The gas vent filter construction of claim 6, wherein said gas-permeable hydrophobic membrane is composed of polyvinylidene fluoride.

8. A vented liquid filtration system suitable for filtering a liquid process stream, the vented liquid filtration system comprising:
a filtration housing defining a filtration passage having a filtration inlet and a filtration outlet, said filtration passage capable of containing a liquid process stream flowing therethrough;
a selectively-permeable filtration element positioned in said filtration passage between said filtration inlet and said filtration outlet such that said liquid process stream must pass through said filtration element as said stream flows through said filtration passage; and
the gas vent filter construction of claim 2 coupled with said filtration passage through said filtration housing at a position between said filtration inlet and said selectively-permeable filtration element, said at least one hollow fiber membrane extending between said passage of the gas vent filter construction and said filtration passage of the filtration system, said plug of said gas vent filter construction blocking said liquid process stream from flowing into the passage of said gas vent filter construction.

9. The vented liquid filtration system of claim 8, wherein said selectively-permeable filtration element is a substantially planar membrane.

10. The vented liquid filtration system of claim 8, wherein said selectively-permeable filtration element is a cylindrically-shaped filter cartridge.

11. The vented liquid filtration system of claim 10, wherein said hollow fiber membrane assembly comprises a bundle of hollow fiber membranes.

12. The vented liquid filtration system of claim 8, wherein all of the hollow fiber membranes of said hollow fiber membrane assembly are substantially hydrophobic, whereby aqueous liquid species are substantially impeded from admission into said passage.

13. The vented liquid filtration system of claim 8, further comprising:
a gas-permeable membrane positioned in said passage between said inlet and said outlet, whereby gas flowing through said passage must pass through said gas-permeable membrane.

14. The vented liquid filtration system of claim 12, further comprising:
a gas-permeable hydrophobic membrane positioned in said passage between said inlet and said outlet, whereby gas flowing through said passage must pass through said gas-permeable hydrophobic membrane.

15. The gas vent filter construction of claim 1, wherein said hollow fiber membrane assembly is formed of one or more hollow fiber membranes and wherein the one or more hollow fiber membranes are substantially hydrophobic, whereby aqueous liquid species are substantially impeded from admission into said passage.
